(19) United States
(12) Patent Application Publication
(10) Pub. No.: US 2004/0205216 A1
(43) Pub. Date: Oct. 14, 2004

(54) Efficient message packaging for transport

(76) Inventors: Keith W. Ballinger, North Bend, WA (US); Chadwin J. Mumford, Woodinville, WA (US); Hervey O. Wilson, Bellevue, WA (US); HongMei Ge, Issaquah, WA (US); Yann Erik Christensen, Seattle, WA (US)

Correspondence Address: RICK D. NYDEGGER, WORKMAN, NYDEGGER & SEELEY, 1000 Eagle Gate Tower, 60 East South Temple, Salt Lake City, UT, 84111, US

(21) Appl. No.: 10/391,838

(22) Filed: Mar. 19, 2003

(51) Int. Cl. G06F 15/16

(52) U.S. Cl. 709/231; 709/206

(57) ABSTRACT

A messaging transport writer is provided that efficiently packages a massage and multiple message attachment streams into a single transport stream, based on a specified encapsulation format. For example, a packaging writer is provided that takes the message and multiple attachments and streams them directly into the single transport stream, without first coping them into a buffer prior to encapsulation. The encapsulation information is streamed into the transport stream on the fly, i.e., as the message and attachment streams are also being written to the transport stream.

### CROSS-REFERENCE TO RELATED APPLICATIONS

N/A

### BACKGROUND OF THE INVENTION

1. The Field of the Invention

The present invention generally relates to sending and receiving message attachments. More particularly, the present invention provides an efficient way to send and receive attachment files by directly steaming them to and from the transport stream.

2. Background and Relevant Art

Messaging systems have become an extremely popular way to communicate. Every day, the citizens of the Internet send each other billions of e-mail messages. With its growth in popularity, much advancement has been made to e-mail systems in an attempt to increase their flexibility, compatibility, reliability and efficiency. There is, however, room for improvement.

Early on, a typical e-mail message was nothing more than a short simple text message. The ability, however, to add attachment files may make e-mail messages E quite long. As discussed in greater detail below, the length of these attachments can cause efficiency problems, especially when allocating memory for composing the message for transport.

Attachments might include word processing documents, spreadsheets, sound files, snapshots, images, multimedia files, software, another text message, and the like. Normally, these attachments include binary data rather than only text characters. Accordingly, because e-mail messages were initially designed to contain only text information, there were problems in dealing with these attachment files. Initially, the solution involved tricking e-mail into sending binary data, but first the binary data was disguised as printable characters. The technique of sending binary data as printable characters has become known as a translation or encoding scheme.

One of the earliest encoding systems used to disguise a complex object containing binary data to look like printable text was uuencoding. For example, uuencoding assumes that the attachment file contains binary information, and extracts three bytes at a time from the file. The three bytes are then converted to four text characters, thereby producing an encoded version of the original binary data that contains only text characters. A recipient then uudecodes the encoded message to translate it back to binary data. As discussed below, however, this encoding and decoding of data is often not a desirable or an efficient way to handle binary data.

A current and more popular encoding scheme for e-mail attachment is known as Multipurpose Internet Mail Extensions, or MIME. MIME refers to an official Internet standard that specifies how certain messages must be formatted so that they can be exchanged between different e-mail systems. MIME is a flexible format, permitting one to include virtually any type of file or document as an attachment to an e-mail message. Similar to uuencode, MIME encodes the binary data using base 64 encoding to insure that the binary data in attachments will be delivered without corruption. The distinguishing characteristic of MIME messages, however, is the presence of the MIME custom headers, which use special strings to separate multiple message attachments and allow one to include additional metadata in the message. While these features make MIME flexible and explain its wide use in today's Internet, they also tend to make for a less efficient protocol. Further, because MIME encodes the binary data, it too has undesirable effects and efficiency problems, as discussed in greater detail below.

A relatively new and evolving communication protocol for sending messages via the Internet is known as Simple Object Access Protocol, or SOAP. SOAP is based on the Extensible Markup Language (XML), which is a markup language for structuring, storing and sending data. SOAP provides a way to communicate between applications running on different operating systems, with different technologies and programming languages. Accordingly, SOAP is platform and language agnostic, yet simple and extensible.

A SOAP message is an XML document containing several elements. FIG. 1 shows a diagram of a standard SOAP Envelope 100. The required Envelope 100 is the root element of a SOAP message and identifies the XML document as a SOAP message. An optional Header element 110 contains application specific information (e.g., authentication, payment and other information) about the SOAP message. If the Header element 110 is present, it must be the first child element of the Envelope element 100. A required Body element 120 contains call and response information, which is the actual SOAP message intended for the ultimate endpoint or recipient. An optional Fault element 130 provides information about errors that occurred while processing the message. If a Fault element 130 is present, it must appear as a child element of the Body element 120. The SOAP Fault element 130 has the following sub elements: a code for identifying the fault, a human readable explanation of the fault, information about who caused the fault to happen, and also holds application specific error information related to the Body element 120.

One of the key strengths of SOAP is the ability to encapsulate XML data within a SOAP message. This gives SOAP the flexibility to contain data from any XML schema, which is quite empowering. Despite the power of XML, however, there are scenarios in the broad realm of application design where it desirable to send binary data (such as a JPEG image) along with a SOAP message. In other circumstances, it also might be appropriate to simply package message data together. For example, one SOAP message might include another SOAP message, as one commonly sees with e-mail messages that have attached e-mail messages included with them. Accordingly, there remains a need to efficiently deal with the transfer of binary data and other attachments within a SOAP message.

One solution to the attachment problems in SOAP might be to create layered architectures that convert data from legacy formats to XML and back. Similar to the encoding schemes in uuencode and MIME, however, encoding may be undesirable in certain circumstance. For example, in an electronic data interchange (EDI) system generating EDI documents for transfer between two businesses, there is a good chance that systems already in place on both sides only speak EDI. Accordingly, in order to use the capabilities of XML Web Services and take advantage of an HTTP infrastructure for sending messages, the documents could be converted to XML for transferring within a SOAP envelope. In this scenario, however, the document not only needs to be converted to XML for transfer; it also needs to be reconverted back to the legacy EDI format for the other side to process. Clearly there would be efficiencies gained by simply including the data in its legacy format, so that it would not have to be encoded and decoded for the simple act of transferring the message.

There are also situations where converting data into XML or other encoding processes will cause further inefficiencies. In particular, there are cases where converting data into some other form for transfer is unwise because an efficient binary compression scheme already exits to insure a manageable size for the data. Take for instance image files that come in a number of different formats, but tend to be transferred across the Web in mostly JPEG or GIF formats. Both of these formats for holding image data are highly structured and could be converted into, e.g., an XML schema. Nevertheless, images are large enough as it is, and the processing required to convert the data to and from XML would slow down a mechanism that is well accepted and efficient.

Another situation where the conversion of binary data associated with a message potentially causes problems is with binary data that is digitally signed.

Regardless of the encoding or conversion used, another problem associated with sending attachment files with messages is the memory allocation requirements for large attachments. When an e-mail message is created with attachments, the message and its attachments generally are copied into a buffer where they are formatted for a particular transport protocol. For example, when sending a message with attachments over HyperText Transfer Protocol (HTTP) using MIME, the message and its attachments are copied into a buffer and formatted with appropriate headers and other MIME information. The formatted message is then transferred to the HTTP transport stream for sending to an endpoint or recipient. Regardless of the attachment file size, however, the copying process may require significant amounts of memory and processing, thereby slowing down the system and inefficiently using valuable system resources. In a similar vein, attachment files when received may require significant amounts of memory and processing to buffer them before they are copied to disk.

Accordingly, there exists a need for a messaging system, which can write binary and other attachment streams directly to the transport stream, without using an intermediate buffer. Similarly, there exists a need for a messaging system, which can read attachment streams from a transport stream and transfer them directly to other streams, such as a disk file, without first coping them to an intermediate buffer.

### BRIEF SUMMARY OF THE INVENTION

In accordance with exemplary embodiments of the present invention, the above-identified deficiencies and drawbacks of current messaging systems are overcome. For example, exemplary embodiments provide for mechanisms that reduce buffer requirements for sending messages by directly writing attachment streams into a single transport stream. In particular, mechanisms are provided that compose the message and attachment streams, based on an identified encapsulation format, into a single transport stream, without copying the message and attachment streams into one or more intermediate buffers.

In accordance with another example embodiment of the present invention, a messaging system for sending a message, which comprises both a message record and a plurality of attachment streams, is provided. The plurality of attachment streams are selected to be included in the message, and an encapsulation format for the plurality of attachment streams and message record is specified. A transport stream is also specified, wherein the plurality of attachment streams, the message record and certain metadata are written into a single transport stream, without composing the message into one or more intermediate buffers. The metadata written to the single transport stream may be based upon the specified encapsulation format.

In accordance with yet another example embodiment of the present invention, a messaging system for receiving a message, which comprises both a message record and a plurality of attachment streams, is provided. A transport stream is received, which includes the message record and the plurality of attachment streams. The attachment streams are identified and spooled directly from the transport stream to disk, without buffering or copying them into temporary memory.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a standard SOAP Envelope;

FIG. 2 illustrates the record organization within a Direct Internet Message Encapsulation (DIME) message;

FIG. 3 illustrates a DIME data record format;

FIG. 4 illustrates a DIME message that includes record chunks;

FIG. 5 illustrates a packaging transport writer in accordance with example embodiments of the present invention;

FIG. 6 shows example acts and steps for methods of streaming attachments and message records to a transport stream in accordance with the present invention; and

FIG. 7, illustrates an example system that provides a suitable operating environment for the present invention.

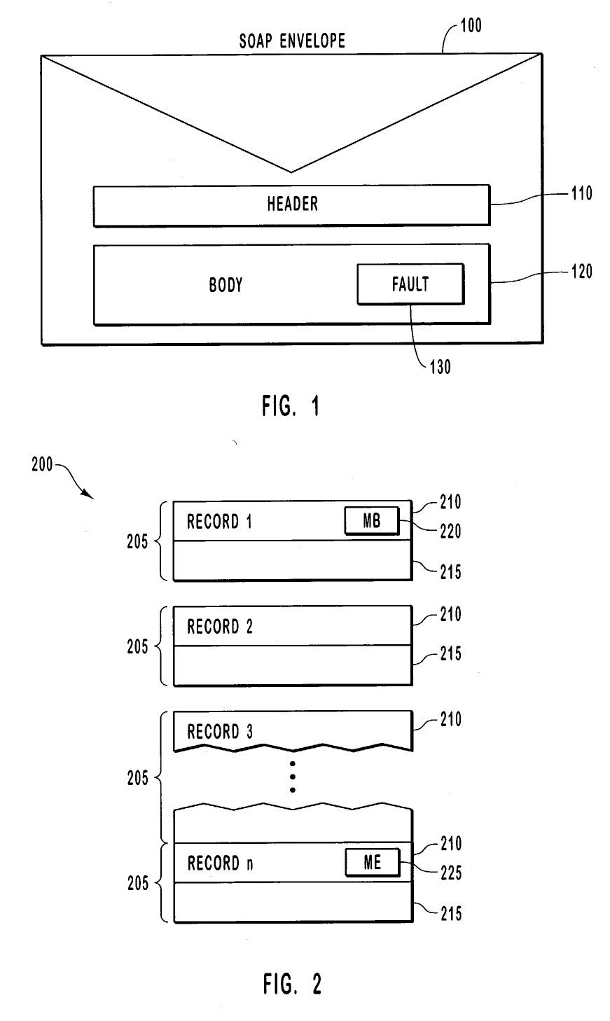

### DETAILED DESCRIPTION OF THE PREFERRED EMBODIMENTS

The present invention extends to methods, systems, and computer program products for writing and reading attachment streams onto a single transport stream. The embodiments of the present invention may comprise a special purpose or general-purpose computer including various computer hardware, as discussed in greater detail below.

There are a number of ways to package a message and its attachments for transport over a network. In the streaming world of the Internet and other networks, it is important that a message packaging system provide a mechanism for passing the different parts of a message over a single transport stream. This allows message packages to be passed over many popular protocols, such as Transmission Control Protocol (TCP), HyperText Transfer Protocol (HTTP), and Simple Mail Transfer Protocol (SMTP). Often, this means that message packaging software has the ability to delineate where one part of a message package ends and the next part begins, and has some mechanism for indicating when the message package is complete.

Direct Internet Messaging Encapsulation (DIME) is mechanism for packaging messages that allows multiple records of arbitrarily formatted data to be streamed together. Records are serialized into the stream one after the other and are delineated with a binary header. FIG. 2 shows the record organization within a DIME message 200. The DIME message 200 consists of one or more records 205 with no restriction on the number of records in the entire message 200. Each record 205 has headers 210 and data 215 associated with it. Among other items, the record header 210 includes various flags 220 and 225. These include a flag to indicate that a record is the first in the DIME message (i.e., Message Begin flag 220), and another flag to indicate that a record is the last in the DIME message (i.e., Message End flag 225).

The size of the data 215 in each record can vary in length. Further, the sequence of the data records 210 is significant, and should be maintained over whatever channel is being used to transmit the DIME message. By using Begin and End Message flags, 220 and 225 respectively, DIME eliminates the need for an application to know the precise length of the entire DIME message before it starts to send it.

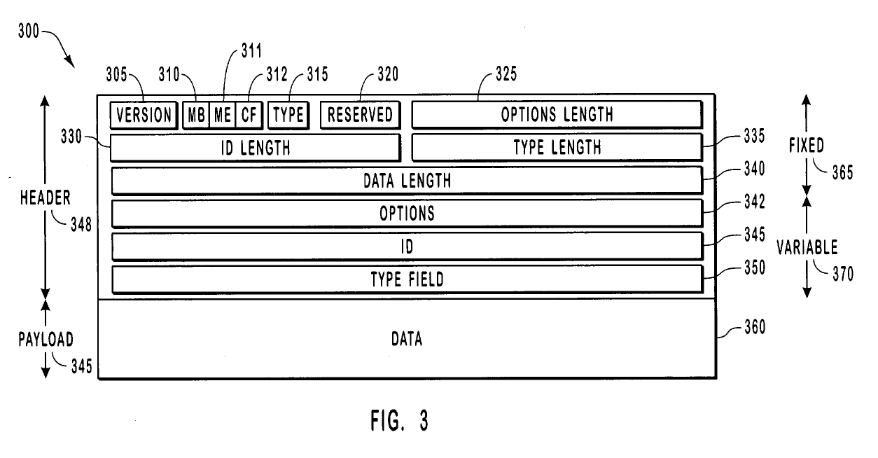

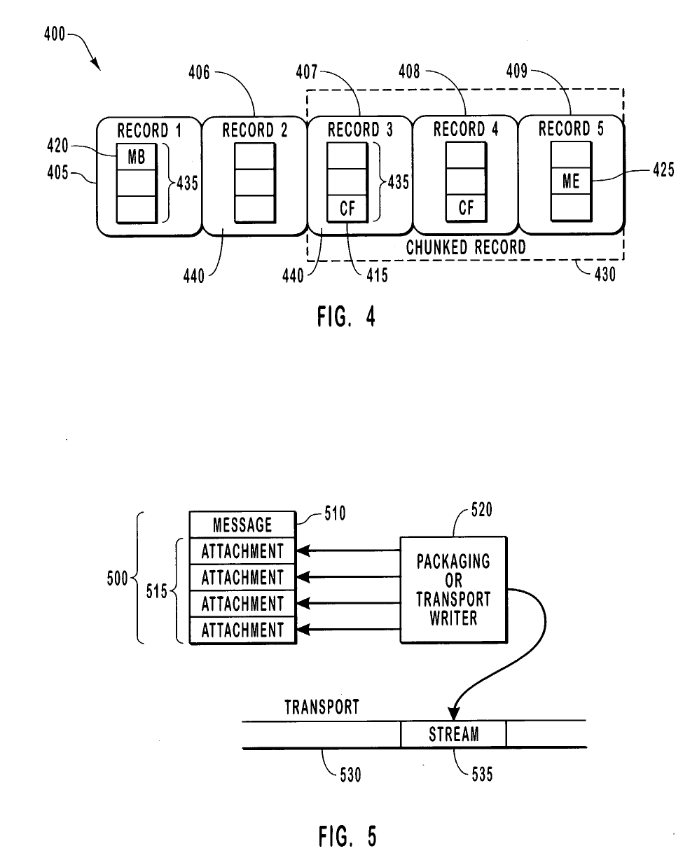

An example of a DIME data Record format 300 is shown in FIG. 3 in two parts, Header 348 and Data Payload 345. The Header 348 is also divided into two parts with Fixed and Variable Length portions 365 and 370, respectively. The first bits allocated in the Fixed Length Header 365 are reserved for the Version 305 of the DIME encapsulation being used. The next three bits 310, 311 and 312 shown in the first line are a bitmask that represents three different flags that describe the Record 300. The first two bits 310 and 311 are used to indicate the two flags 220 and 225, respectively, described above in FIG. 2. MB 310 is the Message Begin Flag and ME 311 is the Message End Flag. The third bit 312 is the Chunked Flag (CF), which indicates that this record is part of a chunked data representation. Chunking data is described in greater detail below with reference to FIG. 4.

The next allocation of bits in the Fixed Length Header 365 is the Type Format 315, which specifies the structure and format of the Type Field 350. Bits 320 are reserved for future expansion. The Options Length bits 325, ID length bits 330 and Type Length bits 335 are used to specify the length (in bytes) of the corresponding Options, ID and Type Fields 342, 345 and 350, respectively, shown in the Variable Length Header 370. The last field in Fixed Header 365 is the Data Length bits 340, which are used to indicate the size (in bytes) of the Data 360.

The Options Field 342 is used to support parsing for any optional information that may be transmitted with a particular record. The ID Field 345 contains a URI for uniquely identifying a DIME payload with any additional padding. The Type Field 350 specifies the encoding for the record based on a type reference URI or a MIME media type; reference type is specified by Type Format 315. Finally, the Data Field 360 contains the actual data Payload 345 for the Record 300. Format of the Data 360 depends on the Type Format 315 specified for the Record 300. The Type Field 350, ID Field 345, Optional data 342, and Data 360 for a Record 300 can all be of varying lengths, while the beginning of the record Header 365 is a fixed portion that includes the Version 305, Flags 310, 311 and 312, and the Lengths 325, 330, 335 and 340 of the four Variable Length portions 342, 345, 350 and 360 of the Record 300.

For large records or records where the size of the data is not initially known, DIME has defined a “record chunk.” DIME uses record chunks to support breaking up a single record into multiple pieces. FIG. 4 illustrates a DIME message 400 with five records 405-409, the last three of the records 407-409 are record chunks that make up a single chunked record 430. Each record chunk 407-409 has a header 435 and a payload 440 like normal records, however, a record chunk has the CF (Chunk Flag) 415 set in the header. This indicates that the data is part of a chunked record 430 and more data for that record will follow. The data for the chunked record 430 is read serially from the record chunks that follow until the last record chunk 409 is determined when the CF 415 is no longer set.

While the following example embodiments are described with reference to the use of DIME and SOAP attachment files, it should be noted that the invention would work with any encapsulation format, including MIME. Nevertheless, the use of DIME in the present invention has various advantageous over other encapsulation formats. For example, DIME provides a simple message format, which in turn provides for faster and more efficient message processing. Further, other message formats, e.g., MINE, must be completely read and interpreted to determine simple things like the number of attachments included in the message. A DIME parser, however, can simply use the data in the record headers to quickly walk through and count the number of records in the message without having to interpret any record data. Other advantageous such as being able to directly write the binary attachment codes into a SOAP envelope without encoding, and not having to reference the attachments in the SOAP message, are also available with DIME formatting.

FIG. 5 illustrates a message packaging transport writer 520 in accordance with example embodiments of the present invention. A layered message 500, which could be a DIME message, is provided with both primary 510 and secondary 515 sections. The primary portion 510 of the layered message 500 includes the message record, e.g., a SOAP message. The secondary portion 515 includes several attachment streams, which can be binary data (e.g., object image data, word processing documents, spreadsheets, sound files, snapshots, multimedia content, software) or other messages. The message packaging or transport writer 520 takes the attachment streams, which may be stored as disk files for example, and places them directly onto the single transport stream 535 of transport 530. This protocol is transport agnostic, meaning that transport 530 can be any transport protocol such as HyperText Transfer Protocol (HTTP), File Transfer Protocol (FTP), Transmission Control Protocol (TCP), Simple Mail Transfer Protocol (SMTP), etc. The attachment streams 515 can also be chunked records, i.e., several of the streams can make up a single record.

It is important to note that transport writer 520 serializes attachment streams 515 and message record 510 directly on the transport stream 535, without copying the message information 515 and 510 into an intermediate buffer. In other words, the attachment streams 515 and the message record 510 are directly written to the transport stream 535 without first copying them into a memory buffer (e.g., into a bit array or other static in-memory binary representation of the data) prior to composing the encapsulation information into the DIME message. More particularly, the metadata identifying each individual attachment stream and message record (e.g., the DIME header information described above) is written to the transport stream 535 on the fly, i.e. as the attachment streams 515 and message record 510 are being directly written to the transport stream 535. Because records 510 and 515 are not copied to memory before putting them directly on the transport 530, the present invention efficiently saves valuable memory and processing resources for other tasks.

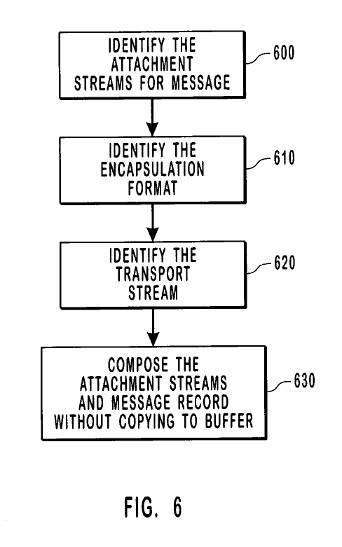

FIG. 6 shows the example steps and acts used to reduce buffer requirements for sending messages with a plurality of attachment streams in accordance with the present invention. In step 600, the attachment streams that are to be included in the message are identified. These attachment streams can be binary data, a text message or a pointer to a network. As previously stated, these attachments streams can vary in size and may be chunked, thereby several streams may represent a single attachment record. A step 600 for identifying the plurality of attachment streams to be included in the message may comprise an act of selecting each of the plurality of attachment streams to be included in the message.

In step 610, the encapsulation format is identified. This encapsulation format can be, e.g., DIME, MIME, etc. A step 610 for identifying an appropriate encapsulation formation may include an act of specifying an encapsulation format for the plurality of attachment streams and message record. Next, the transport stream is identified in step 620. The transport format used, however, can be any format including HTTP, FYP, TCP, SMTP, etc. A step 620 for identifying the single transport stream for the message may include an act of specifying only one of a plurality of available transport streams for transporting the message.

Finally, the attachment streams and the message are serialized or written to the transport stream in step 630, without copying the message record and attachment streams to a buffer. Accordingly, the attachments streams and message record are composed with metadata associated with the particular encapsulation format directly to the transport stream. A step 630 for composing the plurality of attachment streams and message record into the single transport stream may include an act of writing the plurality of attachment streams into the single transport stream without composing the message into one or more intermediate buffers. The message record can be, for example, a SOAP message, which also may reference attachments.

A similar inverse method can be used to receive the message at the endpoint address. In particular, the attachment streams and message record can be identified from the transport stream and spooled directly to another stream, e.g., to disk, without writing the encapsulated message to memory.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

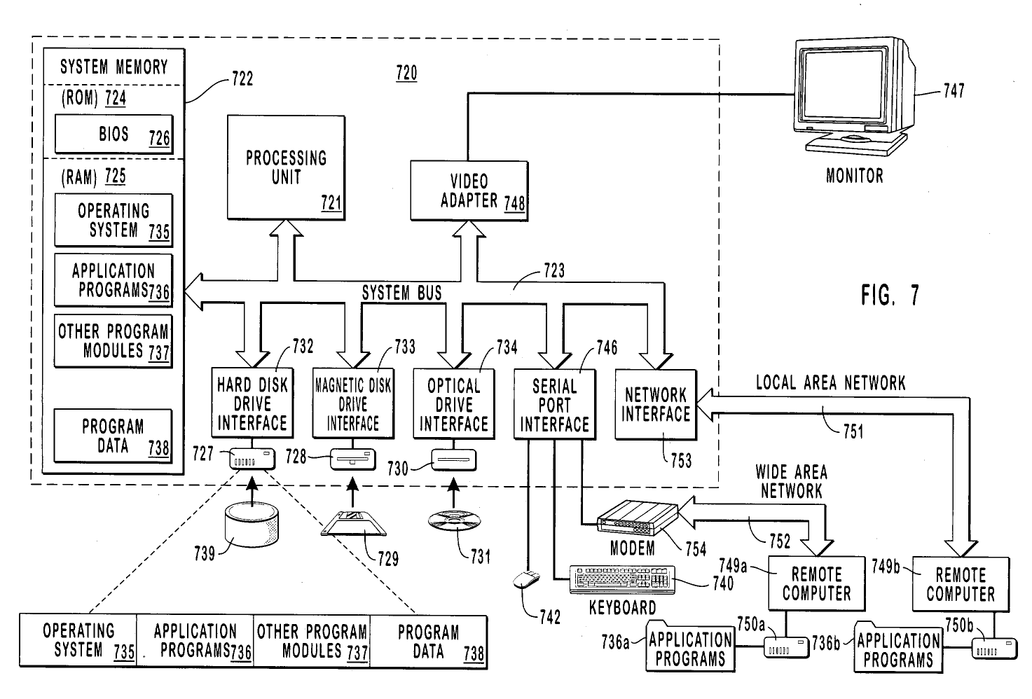

FIG. 7 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 7, an exemplary system for implementing the invention includes a general purpose computing device in the form of a conventional computer 720, including a processing unit 721, a system memory 722, and a system bus 723 that couples various system components including the system memory 722 to the processing unit 721. The system bus 723 may be any of several types of bus structures including a memory bus or memory controller, a peripheral bus, and a local bus using any of a variety of bus architectures. The system memory includes read only memory (ROM) 724 and random access memory (RAM) 725. A basic input/output system (BIOS) 726, containing the basic routines that help transfer information between elements within the computer 720, such as during start-up, may be stored in ROM 724.

The computer 720 may also include a magnetic hard disk drive 727 for reading from and writing to a magnetic hard disk 739, a magnetic disk drive 728 for reading from or writing to a removable magnetic disk 729, and an optical disk drive 730 for reading from or writing to removable optical disk 731 such as a CD-ROM or other optical media. The magnetic hard disk drive 727, magnetic disk drive 728, and optical disk drive 730 are connected to the system bus 723 by a hard disk drive interface 732, a magnetic disk drive-interface 733, and an optical drive interface 734, respectively. The drives and their associated computer-readable media provide nonvolatile storage of computer-executable instructions, data structures, program modules and other data for the computer 720. Although the exemplary environment described herein employs a magnetic hard disk 739, a removable magnetic disk 729 and a removable optical disk 731, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 739, magnetic disk 729, optical disk 731, ROM 724 or RAM 725, including an operating system 35, one or more application programs 36, other program modules 737, and program data 738. A user may enter commands and information into the computer 720 through keyboard 740, pointing device 742, or other input devices (not shown), such as a microphone, joy stick, game pad, satellite dish, scanner, or the like. These and other input devices are often connected to the processing unit 721 through a serial port interface 746 coupled to system bus 723. Alternatively, the input devices may be connected by other interfaces, such as a parallel port, a game port or a universal serial bus (USB). A monitor 747 or another display device is also connected to system bus 723 via an interface, such as video adapter 748. In addition to the monitor, personal computers typically include other peripheral output devices (not shown), such as speakers and printers.

The computer 720 may operate in a networked environment using logical connections to one or more remote computers, such as remote computers 749a and 749b. Remote computers 749a and 749b may each be another personal computer, a server, a router, a network PC, a peer device or other common network node, and typically include many or all of the elements described above relative to the computer 720, although only memory storage devices 750a and 750b and their associated application programs 736a and 736b have been illustrated in FIG. 7. The logical connections depicted in FIG. 7 include a local area network (LAN) 751 and a wide area network (WAN) 752 that are presented here by way of example and not limitation. Such networking environments are commonplace in office-wide or enterprise-wide computer networks, intranets and the Internet.

When used in a LAN networking environment, the computer 720 is connected to the local network 751 through a network interface or adapter 753. When used in a WAN networking environment, the computer 720 may include a modem 754, a wireless link, or other means for establishing communications over the wide area network 752, such as the Internet. The modem 754, which may be internal or external, is connected to the system bus 723 via the serial port interface 746. In a networked environment, program modules depicted relative to the computer 720, or portions thereof, may be stored in the remote memory storage device. It will be appreciated that the network connections shown are exemplary and other means of establishing communications over wide area network 752 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a messaging system for sending a message, the message comprising both a message record and a plurality of attachment streams included within a plurality of attachment records, a method that reduces buffer requirements for sending messages by directly writing the plurality of attachment streams into a single transport stream, without using an intermediate buffer, the method comprising steps for:
identifying the plurality of attachment streams to be included in the message;
identifying an appropriate encapsulation format for the plurality of attachment streams and message record;
identifying the single transport stream for the message; and
composing, based on the identified encapsulation format, the plurality of attachment streams and message record into the single transport stream, without composing the message into one or more intermediate buffers.

2. The method of claim 1, wherein the plurality of attachment streams are composed with metadata identifying each individual attachment stream included within the plurality of attachment records.

3. The method of claim 2, wherein the metadata comprises a header field with at least one of a content name, content size, content type or content type of type.

4. The method of claim 1, wherein the message record comprises a SOAP message.

5. The method of claim 4, wherein the plurality of attachment streams are referenced in the SOAP message.

6. The method of claim 4, wherein the plurality of attachment records are referenced in the SOAP message.

7. The method of claim 6, wherein the plurality of attachment streams are referenced in the SOAP message.

8. The method of claim 1, wherein the plurality of attachment streams vary in size.

9. The method of claim 8, wherein the plurality of attachment records vary in size.

10. The method of claim 1, wherein the encapsulation format identified is DIME.

11. The method of claim 10, wherein the message includes primary and secondary portions, and wherein the primary portion includes the message record and the secondary portion includes the plurality of attachment streams.

12. The method of claim 11, wherein the number of the plurality of attachment streams is identified in the metadata written in the primary part of the message.

13. The method of claim 1, wherein the encapsulation format is MIME.

14. The method of claim 1, wherein the single transport stream format is one of HTTP, FTP, SMTP or TCP/IP.

15. The method of claim 1, wherein at least one of the plurality of attachment streams comprises only a portion of an attachment record.

16. In a messaging system for sending a message, the message comprising both a message record and a plurality of attachment streams included within a plurality of attachment records, a method that reduces buffer requirements for sending messages by directly writing the plurality of attachment streams into a single transport stream, without using an intermediate buffer, the method comprising acts of:
selecting each of the plurality of attachment streams to be included in the message;
specifying an encapsulation format for the plurality of attachment streams and message record;
specifying only one of a plurality of available transport streams for transporting the message; and
packaging the plurality of attachment streams, the message record and metadata into the single transport stream for sending, without writing the message into one or more intermediate buffers, wherein the metadata is based upon the specified encapsulation format.

17. The method of claim 16, wherein the metadata comprises information for identifying each of the plurality of attachment streams.

18. The method of claim 17, wherein the information in the metadata for identifying each of the plurality of attachment streams comprises at least one of a content name, content type or content type of type.

19. The method of claim 16, wherein at least one of the plurality of attachment streams is a pointer to a network.

20. The method of claim 16, wherein at least one of the plurality of attachment streams comprises binary data.

21. The method of claim 16, wherein the message record comprises a SOAP message.

22. The method of claim 21, wherein the plurality of attachment streams are referenced in the SOAP message.

23. The method of claim 21, wherein the plurality of attachment records are referenced in the SOAP message.

24. The method of claim 16, wherein the plurality of attachment streams vary in size.

25. The method of claim 24, wherein the plurality of attachment records vary in size.

26. The method of claim 16, wherein the specified encapsulation format is DIME.

27. The method of claim 26, wherein the message includes primary and secondary portions, and wherein the primary portion includes the message record and the secondary portion includes the plurality of attachment streams included within a plurality of attachment records.

28. The method of claim 27, wherein the number of the plurality of attachment streams is identified in the metadata packaged in the primary part of the message.

29. The method of claim 16, wherein the specified encapsulation format for the plurality of attachment streams and message record is MIME.

30. The method of claim 16, wherein format of the only one selected transport stream for transporting the message is chosen from HTTP, FYP, SMTP or TCP/IP.

31. The method of claim 16, wherein at least one of the plurality of attachment streams comprises only a portion of an attachment record.

32. The method of claim 16, wherein at least one of the plurality of attachment streams is a SOAP message.

33. For a messaging system that sends a message, the message comprising both a message record and a plurality of attachment streams included within a plurality of attachment records, a computer program product comprising one or more computer readable media carrying computer executable instruction that implements a that implements a method that reduces buffer requirements for sending messages by directly writing the plurality of attachment streams into a single transport stream, without using an intermediate buffer, the method comprising steps for:
identifying the plurality of attachment streams to be included in the message;
identifying an appropriate encapsulation format for the plurality of attachment streams and message record;
identifying the single transport stream for the message; and
composing, based on the identified encapsulation format, the plurality of attachment streams and message record into the single transport stream, without composing the message into one or more intermediate buffers.

34. The computer product of claim 33, wherein the plurality of attachment streams are composed with metadata identifying each individual attachment stream included within the plurality of attachment records.

35. The computer product of claim 34, wherein the metadata comprises a header field with at least one of a content name, content size, content type or content type of type.

36. The computer product of claim 33, wherein the message record comprises a SOAP message.

37. The computer product of claim 33, wherein the encapsulation format identified is DIME.

38. The computer product of claim 37, wherein the message includes primary and secondary portions, and wherein the primary portion includes the message record and the secondary portion includes the plurality of attachment streams.

39. The computer product of claim 38, wherein the number of the plurality of attachment streams is identified in the metadata written in the primary part of the message.

40. The computer product of claim 33, wherein the encapsulation format is MIME.

41. The computer product of claim 33, wherein the single transport stream format is one of HTTP, FTP, SMTP or TCP/IP.

42. The computer product of claim 33, wherein at least one of the plurality of attachment streams comprises only a portion of an attachment record.

43. For a messaging system that sends a message, the message comprising both a message record and a plurality of attachment streams included within a plurality of attachment records, a computer program product comprising one or more computer readable media carrying computer executable instruction that implement a method that reduces buffer requirements for sending messages by directly writing the plurality of attachment streams into a single transport stream, without using an intermediate buffer, the method comprising acts of:
selecting each of the plurality of attachment streams to be included in the message;
specifying an encapsulation format for the plurality of attachment streams and message record;
specifying only one of a plurality of available transport streams for transporting the message; and
writing the plurality of attachment streams, the message record and metadata into the single transport stream for sending, without writing the message into one or more intermediate buffers, wherein the metadata written to the single transport stream is based upon the specified encapsulation format.

44. The computer product of claim 43, wherein the metadata written into the single transport stream contains information for identifying each of the plurality of attachment streams.

45. The computer product of claim 43, wherein the information in the metadata for identifying each of the plurality of attachment streams comprises at least one of a content name, content type or content type of type.

46. The computer product of claim 43, wherein at least one of the plurality of attachment streams comprises binary data.

47. The computer product of claim 43, wherein the message record comprises a SOAP message.

48. The computer product of claim 43, wherein the specified encapsulation format is DIME.

49. The computer product of claim 48, wherein the message includes primary and secondary portions, and wherein the primary portion includes the message record and the secondary portion includes the plurality of attachment streams included within a plurality of attachment records.

50. The computer product of claim 43, wherein the specified encapsulation format for the plurality of attachment streams and message record is MIME.

51. The computer product of claim 43, wherein format of the only one selected transport stream for transporting the message is chosen from HTTP, FrP, SMTP or TCP/IP.

52. The computer product of claim 43, wherein at least one of the plurality of attachment streams comprises only a portion of an attachment record.

53. The computer product of claim 43, wherein at least one of the plurality of attachment streams is a SOAP message.

54. For a messaging system that receives a message, the message comprising both a message record and a plurality of attachment streams included within a plurality of attachment records, a computer program product comprising one or more computer readable media carrying computer executable instruction that implement a method that reduces buffer requirements for receiving messages by directly spooling the plurality of attachment streams from a single transport stream to disk, without using an intermediate buffer, the method comprising acts of:
receiving each of the plurality of attachment streams and message record from the single transport stream for reading;
reading metadata based on an encapsulation format used for identifying information about the plurality of attachments; and
writing the plurality of attachment streams directly to another stream, without writing the message into one or more intermediate buffers.

55. The computer product of claim 54, wherein the information in the metadata for identifying each of the plurality of attachment streams comprises at least one of a content name, content type or content type of type.

56. The computer product of claim 54, wherein at least one of the plurality of attachment streams comprises binary data.

57. The computer product of claim 54, wherein the message record comprises a SOAP message.

58. The computer product of claim 54, wherein the specified encapsulation format is DIME.

59. The computer product of claim 54, wherein the message includes primary and secondary portions, and wherein the primary portion includes the message record and the secondary portion includes the plurality of attachment streams included within a plurality of attachment records.

60. The computer product of claim 54, wherein the specified encapsulation format for the plurality of attachment streams and message record is MIME.

61. The computer product of claim 54, wherein format of the only one selected transport stream for transporting the message is chosen from HTTP, FTP, SMTP or TCP/IP.

62. The computer product of claim 54, wherein at least one of the plurality of attachment streams comprises only a portion of an attachment record.

63. The computer product of claim 54, wherein at least one of the plurality of attachment streams is a SOAP message.
